(19) United States
(12) Patent Application Publication
(10) Pub. No.: US 2022/0382883 A1
(43) Pub. Date: Dec. 1, 2022

(54) Data Cube

(71) Applicant: AT&T Intellectual Property I, L.P., Atlanta, GA (US)

(72) Inventor: Yeeling Lam, Bridgeton, MO (US)

(73) Assignee: AT&T Intellectual Property I, L.P., Atlanta, GA (US)

(21) Appl. No.: 17/333,066

(22) Filed: May 28, 2021

(51) Int. Cl. G06F 21/60; G06F 21/62; H04L 29/06

(52) U.S. Cl. CPC G06F 21/602; G06F 21/6245; H04L 63/0478

(57) ABSTRACT

Concepts and technologies disclosed herein are directed to a data security cube with a key cube. According to one aspect of the concepts and technologies disclosed herein, a system can execute a data security cube application. The application can receive user data associated with a user. The application can create a data cube that includes at least one data layer that, in turn, includes the user data represented in a binary format. The application can create a key cube that includes at least one key layer that, in turn, includes a data type of the user data, an element identifier that identifies a location of the user data within the data cube, and a decryption logic that decrypts the user data in the binary format. The application can store the data cube and the key cube in secure storage component of the system.

### BACKGROUND

Technology has become increasingly more personalized and invasive, and this trend is likely to continue. Websites, products, social media platforms, companies, and other entities often request and sometimes require that a user provide personal data to allow full use of their offerings. Since this has become standard practice, many users feel they have no other choice but to provide their personal data to these data requestors. This practice has increased complacency among users and their willingness to provide personal data. This personal data is often stored by the data requestor with little or no control provided to the user to ensure their data remains secure.

### SUMMARY

Concepts and technologies disclosed herein are directed to a data security cube. According to one aspect of the concepts and technologies disclosed herein, a system can execute a data security cube application. The data security cube application can receive user data associated with a user. In some embodiments, the data security cube application can create a data cube that includes at least one data layer that, in turn, includes the user data represented in a binary format. In some other embodiments, the data security cube application can create a data cube that includes at least one data layer that, in turn, includes the user data represented in an intensity (e.g., expressed as a decimal such as 0.10010) format. The data security cube application can create a key cube that includes at least one key layer that, in turn, includes a data type of the user data, an element identifier that identifies a location of the user data within the data cube, and a decryption logic that decrypts the user data in the binary or intensity format. In some embodiments, the decryption logic can be different based upon the sensitivity of the user data or some portion thereof. The data security cube application can store the data cube and the key cube in a secure storage component. The secure storage component can be part of the system or a private cloud space.

In some embodiments, the data security cube application can receive a data request from a data requestor, such as a website, product (or associated product platform), company, or other entity. The data request can identify at least a portion of the user data requested by the data requestor. The data security cube application can perform a lookup operation to obtain at least one binary value that corresponds to at least the portion of the user data. The data security cube application can translate the at least one binary value into an ASCII text. The data security cube application can send the data response to the data requestor.

In some embodiments, the data security cube application can determine that a default expiration calculation should be used to calculate an expiration time for the ASCII text. The data security cube application can calculate, based upon the default expiration calculation, the expiration time for the ASCII text. In these embodiments, the data security cube application can create the data response that further includes the expiration time for the ASCII text.

In some embodiments, the data security cube application can receive an expiration time. The user may enter the expiration time via a user interface provided by the data security cube application. In these embodiments, the data security cube application can create the data response that further includes the expiration time for the ASCII text.

In some embodiments, the data security cube application can receive a data request from a data requestor. The data security cube application can obtain a key layer from the key cube and a corresponding data layer from the data cube. The data layer can include at least a portion of the user data. The data security cube application can create a data response that includes the key layer and the data layer. The data security cube application can send the data response to the data requestor.

In some embodiments, the data security cube application can determine that a default expiration calculation should be used to calculate an expiration time for the key layer and the data layer. The data security cube application can calculate, based upon the default expiration calculation, the expiration time for the key layer and the data layer. The data security cube application can create the data response that further includes the expiration time for the key layer and the data layer.

In some embodiments, the data security cube application can receive new user data associated with the user. The data security cube application can create a new data layer in the data cube to accommodate the new user data, thereby creating an updated data cube. The data security cube application can store the updated data cube and the updated key cube in the secure storage.

In some embodiments, the data security cube application can create an image by combining three or more data layers (e.g., red layer, green layer, and blue layer) in the data cube. The data security cube application can present the image in the data cube. In this manner, the user can view their data over time. In some embodiments, the image is a static image. In other embodiments, the image is a video image, wherein each frame of the video image includes one static image created from three or more data layers. The video image can be used as a cryptic sequence that uniquely represents the user (data owner). The data security cube application can receive input to manipulate the image. The data security cube application can manipulate the image in accordance with the input.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating an operating environment in which aspects of the concepts and technologies disclosed herein can be implemented.

FIG. 2 is a diagram illustrating an example data cube, according to an illustrative embodiment.

FIG. 3 is a diagram illustrating an example key cube, according to an illustrative embodiment.

FIG. 4 is a flow diagram illustrating aspects of a method for creating a new data cube and a new key cube, according to an illustrative embodiment.

FIG. 5 is a flow diagram illustrating aspects of a method for responding to a text-based data request, according to an illustrative embodiment.

FIG. 6 is a flow diagram illustrating aspects of a method for responding to a data cube-based data request, according to an illustrative embodiment.

FIG. 7 is a flow diagram illustrating aspects of a method for updating a data cube and a key cube, according to an illustrative embodiment.

FIG. 8 is a flow diagram illustrating aspects of a method for creating and manipulating a static image of a data cube, according to an illustrative embodiment.

FIG. 9 is a flow diagram illustrating aspects of a method for creating and manipulating a video of a data cube, according to an illustrative embodiment.

FIG. 10 is a block diagram illustrating an example computer system capable of implementing aspects of the embodiments presented herein.

FIG. 11 is a block diagram illustrating an example mobile device and components thereof capable of implementing aspects of the embodiments presented herein.

FIG. 12 is a block diagram illustrating an example virtualized cloud architecture and components thereof capable of implementing aspects of the embodiments presented herein.

FIG. 13 is a diagram illustrating a network, according to an illustrative embodiment.

### DETAILED DESCRIPTION

While the subject matter described herein may be presented, at times, in the general context of program modules that execute in conjunction with the execution of an operating system and application programs on a computer system, those skilled in the art will recognize that other implementations may be performed in combination with other types of program modules. Generally, program modules include routines, programs, components, data structures, computer-executable instructions, and/or other types of structures that perform particular tasks or implement particular abstract data types. Moreover, those skilled in the art will appreciate that the subject matter described herein may be practiced with other computer systems, including hand-held devices, mobile devices, wireless devices, multiprocessor systems, distributed computing systems, microprocessor-based or programmable consumer electronics, minicomputers, mainframe computers, routers, switches, other computing devices described herein, and the like.

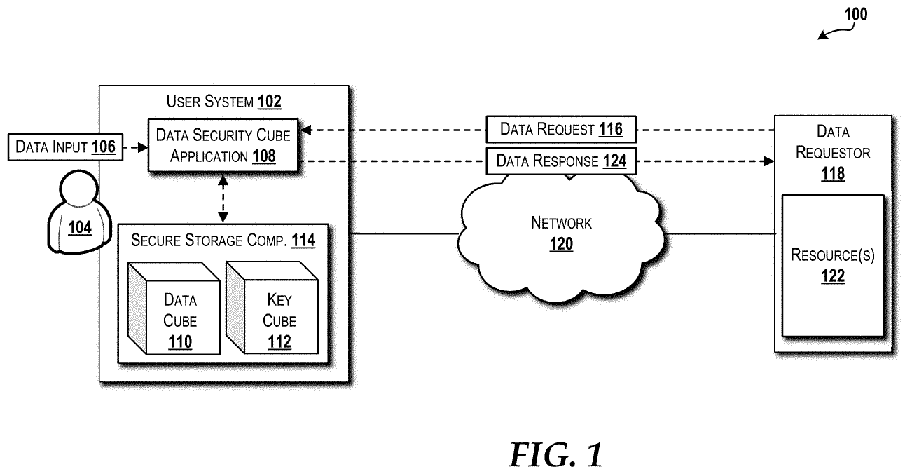

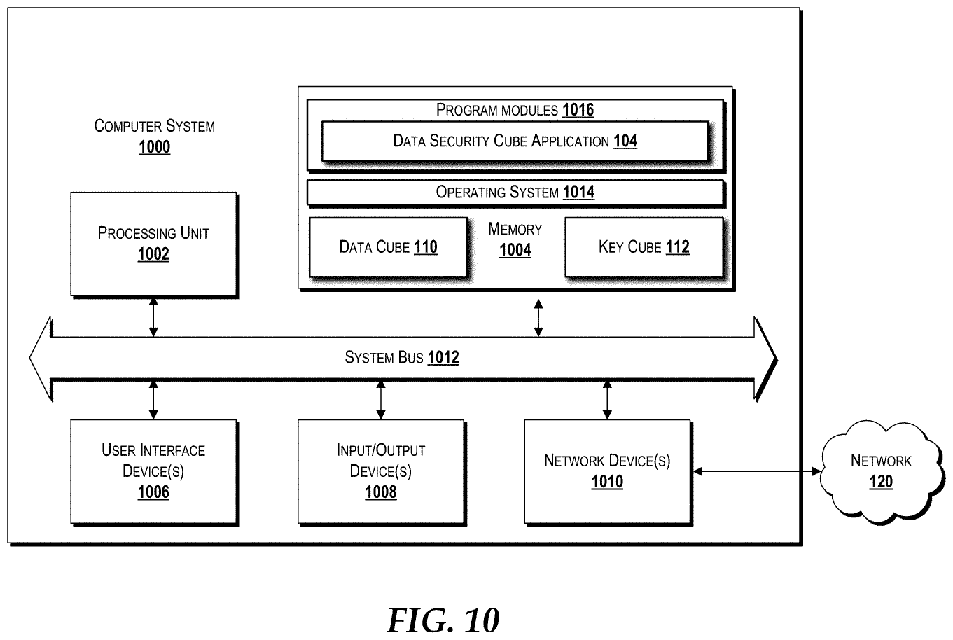

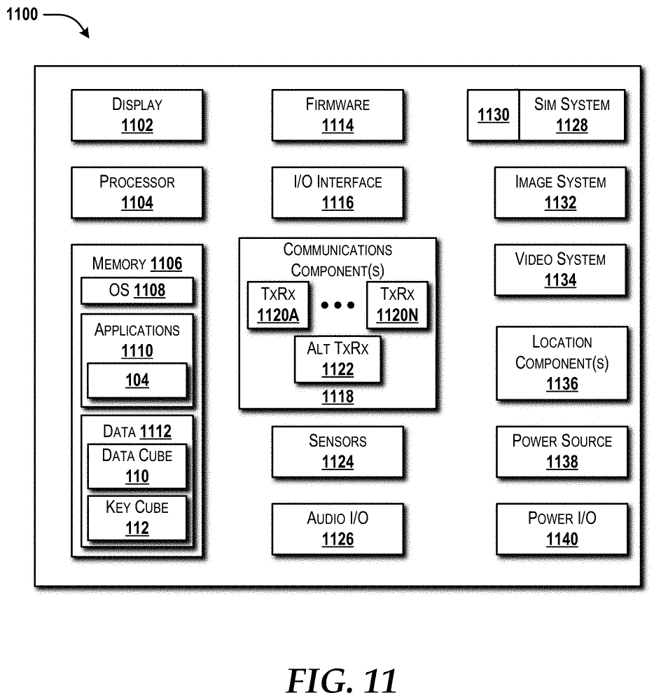

Referring now FIG. 1, a block diagram of an operating environment 100 in which aspects of the concepts and technologies disclosed herein can be implemented will be described. The operating environment 100 includes a user system 102 associated with a user 104. The user system 102 can be any system or device capable of receiving a data input 106. The user system 102 may, for example, be configured the same as or similar to a computer system 1000 that is illustrated and described herein with reference to FIG. 10. Alternatively, the user system 102 may, for example, be configured the same as or similar to a mobile device 1100 that is illustrated and described herein with reference to FIG. 11. The user system 102 may receive the data input 106 directly from the user 104. The user system 102 may receive the data input 106 indirectly from the user 104, such as on behalf of the user 104 from another user (e.g., a friend, family member, or co-worker), another entity, or another system or device (not shown). The data input 106 can include any data, but the full benefit of the concepts and technologies disclosed herein may be derived from the data input 106 that includes personal data, financial data, medical data, other sensitive data, or some combination thereof.

The user system 102 can include one or more processing components (best shown in FIGS. 10 and 11) and one or more memory/storage components (also best shown in FIGS. 10 and 11). The user system 102 can execute, via the processing component(s), a data security cube application 108 that can be stored in the memory/storage components. The data security cube application 108 can receive the data input 106 and can create a data cube 110 and a key cube 112 for storing the data input 106 in a secure storage component 114 of the user system 102.

The data cube 110 is a data structure used to securely store data, such as provided via the data input 106, in one or more data layers. The key cube 112 is a data structure used to store decryption key information to decipher the data stored in the data cube 110. Although described herein as a “cube,” it should be understood that the dimensions of each layer and the total dimensions of these data structures may be represented in a shape other than a cube. Accordingly, the term “cube” should not be interpreted as being limited to a data structure with dimensionality consistent with that of a mathematical cube. In other words, the “cube” does not necessarily require six square faces, eight vertices, and twelve edges of a mathematical cube.

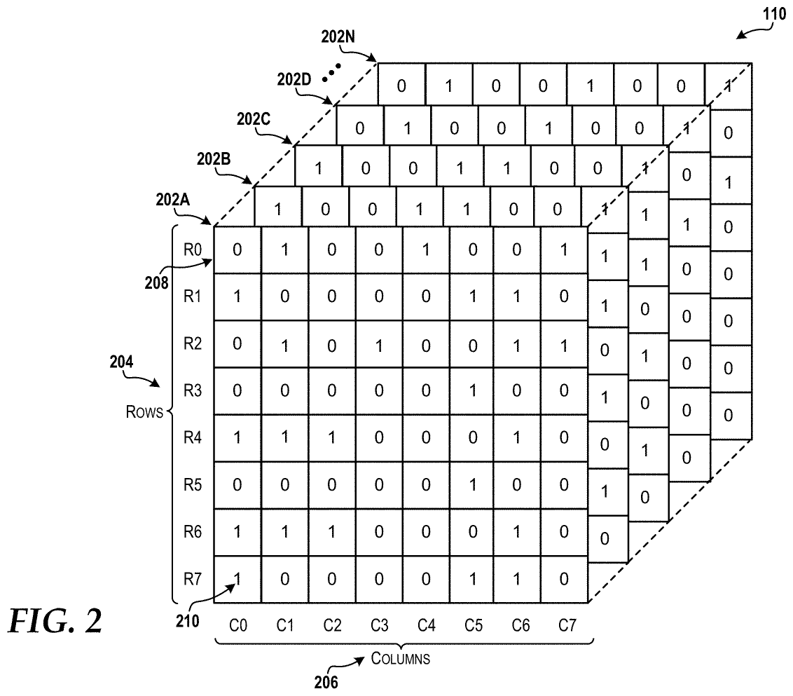

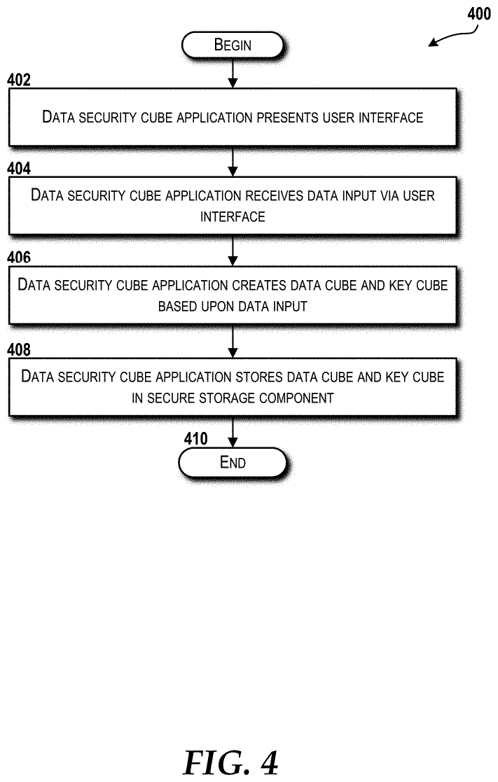

Turning briefly to FIG. 2, an example data cube 110 will be described, according to an illustrative embodiment. The example data cube 110 can include a plurality of data layers 202A-202N (hereinafter referred to collectively as “data layers 202” or individually as “data layer 202”). Each data layer 202 can include a plurality of rows 204 (also referred to individually as “row 204”) and a plurality of columns 206 (also referred to individually as “column 206”) that form a plurality of cells 208 (also referred to individually as “cell 208”). Each cell 208 can contain a binary value 210 that is representative of a portion of the data input 106. The key cube 112 is used to decrypt the binary values 210 contained in the data cube 110 to obtain the data input 106. In some embodiments, the binary value 210 can be replaced by an intensity value that is represented as a decimal (e.g., 0.10010). Additional details about the creation of the data cube 110, the use of the data cube 110, how the data cube 110 can be updated, and other aspects of the data cube 110 will be described herein with reference to FIGS. 4-9.

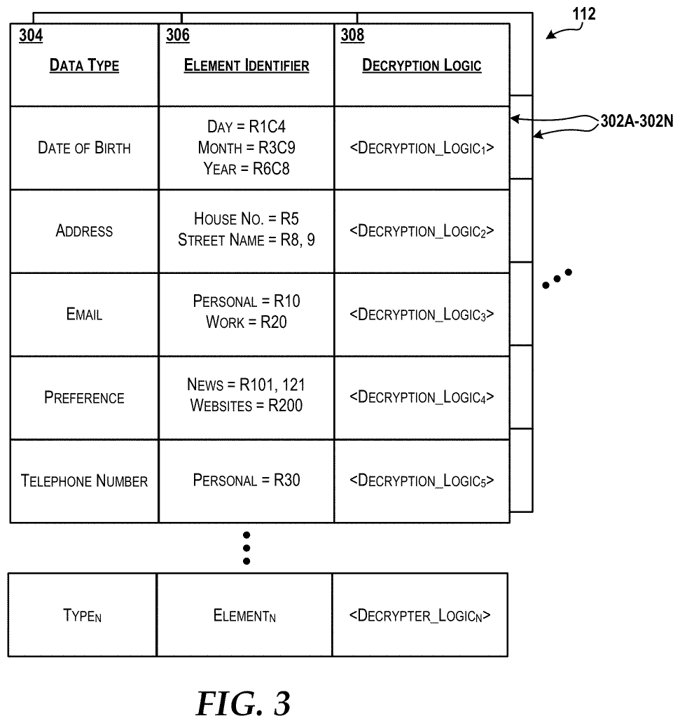

Turning briefly to FIG. 3, an example key cube 112 will be described, according to an illustrative embodiment. The example key cube 112 can include a plurality of key layers 302A-302N (hereinafter referred to collectively as “key layers 302” or individually as “key layer 302”). Each key layer 302 can include a data type column 304, an element identifier column 306, and a decryption logic column 308. The data type column 304 can include one or more rows that identify a data type of a portion of the data input 106. In the illustrated example, the data types in the data type column 304 include “date of birth” of the user 104, “address” of the user 104, “email” of the user 104, “preference” of the user 104 (e.g., news source and web site preferences), and “telephone number” of the user 104. These data types are merely exemplary examples of some data types that can be included in the data type column 304. The data types that can be identified in the key cube 112 should not be limited in any way. The element identifier column 306 identifies a location of user data within the data cube 110. In the illustrated example, the day of the date of birth can be found at row 1 (R1), column 4 (C4); the month of the date of birth can be found at row 3 (R3), column 9 (C9); and the year of the date of birth can be found at row 6 (R6), column 8 (C8). This example is simplified, and in practice, data can be stored in the data cube 110 across any number of rows/columns. The decryption logic column 308 provides the decryption logic used to translate the binary values 210 contained in the cells 208 of the data cube 110 into the original data input 106. Additional details about the creation of the data cube 110, the use of the data cube 110, how the data cube 110 can be updated, and other aspects of the data cube 110 will be described herein with reference to FIGS. 4-9.

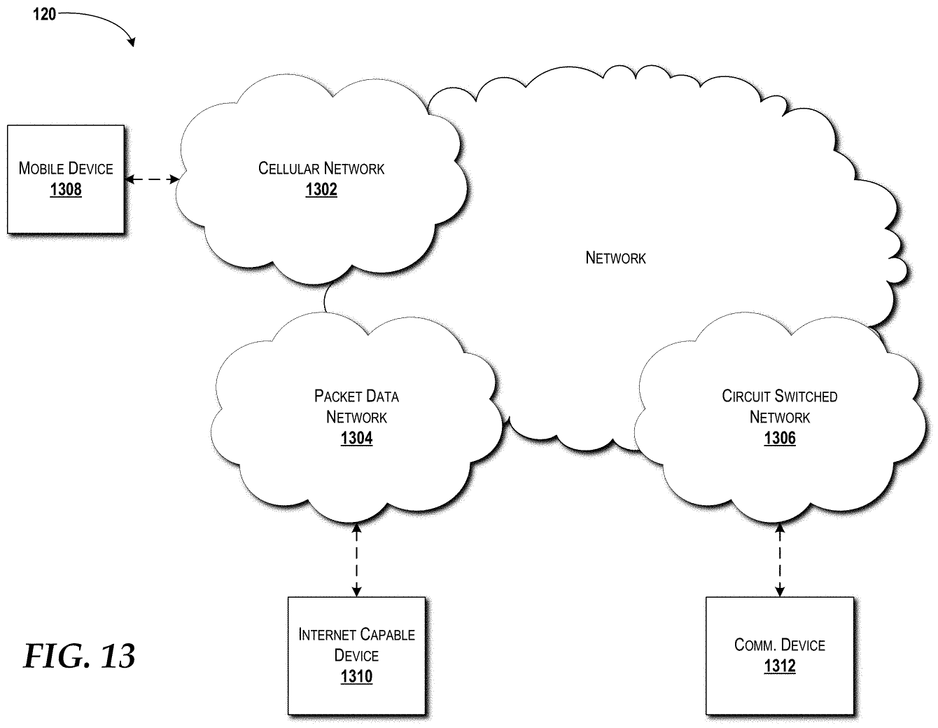

Returning to FIG. 1, the data security cube application 108 can receive one or more data requests 116 from a data requestor 118 via a network 120. The data requestor 118 can be any system, server, device or other computing component that is capable of requesting data that is associated with the user 104. The data requestor 118 can be or can be associated with associated with a website, product (or associated platform), social media platform, company, and other entity. The network 120 can be any network or combination of networks, some examples of which will be described herein with reference to FIG. 13.

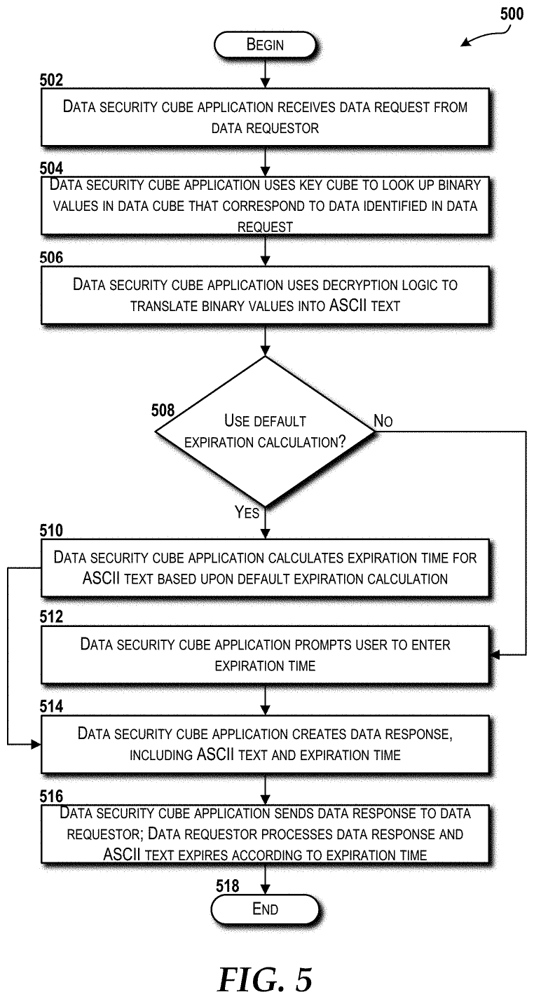

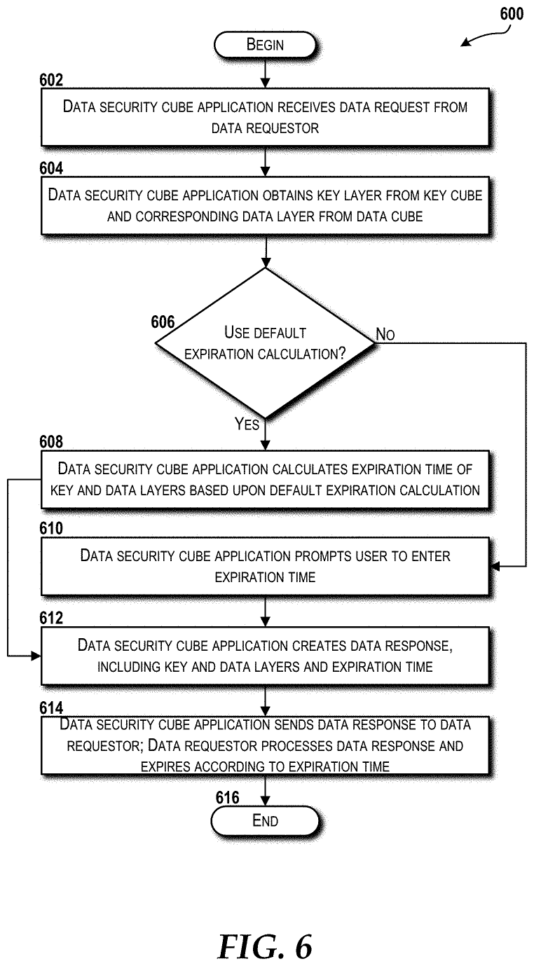

For ease of explanation, the data requestor 118 will be described as a website hosted on a web server. The data requestor 118 can include one or more resources 122 that the user 104 wants to utilize. As a website, the resources(s) 120 can include a web page. Extending this example, the data request 116 can be implemented as part of the website via a web form, prompt, or other web element, which may be implemented using any web technologies such as, but not limited to, Extended Markup Language (“XML”) or JavaScript Object Notation (“JSON”). Regardless of the format in which the data request 116 is sent, the data security cube application 108 can obtain the data request 116 and use the data cube 110 and the key cube 112 to obtain the requested data to be sent back to the data requestor 118 in a data response 124. Additional details in this regard will be described herein with reference to FIGS. 5 and 6.

The data request 116 can be embodied as a text-based data request 116 (see FIG. 5) or a data cube-based data request 116 (see FIG. 6). The text-based data request 116 can be used when the data requestor 118 does not natively support data cubes. In this implementation, the data security cube application 112 can respond to the text-based data request 116 with ASCII text. The data cube-based data request 116 can be used when the data requestor 118 natively supports data cubes. In this implementation, the data security cube application 112 can respond to the data cube-based data request 116 with the key layer 302 from the key cube 112 and the corresponding data layer 202 from the data cube 110 for the data identified in the data cube-based data request 116.

Turning now to FIG. 4, a flow diagram illustrating aspects of a method 400 for creating a new data cube and a new key cube will be described, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor or multiple processors of one or more systems and/or one or more devices disclosed herein to perform one or more operations and/or causing the processor to direct other components of the computing system or device to perform one or more of the operations.

The method 400 begins and proceeds to operation 402. At operation 402, the data security cube application 108 presents a user interface. From operation 402, the method 400 proceeds to operation 404. At operation 404, the data security cube application 108 receives the data input 106 via a user interface provided by the data security cube application 108. From operation 404, the method 400 proceeds to operation 406. In some embodiments, the user interface can provide multiple options for different encryption logics. The user interface may suggest a particular encryption logic based upon data type or some other criteria. The user 104 can select the same encryption logic for the entirety of the data input 106 or different encryption logics for different portions of the data input 106. Some portion(s) of the data input 106 may be left unencrypted. For example, a name and other contact information of the user 104 may be left unencrypted, but financial information may be encrypted using a highest level of available encryption (e.g., Advanced Encryption Standard (“AES”) 256-bit). In some embodiments, the encryption logics can be auto-selected. The auto-select criteria can be pre-established by the user 104.

At operation 406, the data security cube application 108 creates the data cube 110 and the key cube 112 based upon the data input 106. In some embodiments, the data security cube application 108 can auto-encrypt the data input 106 based upon any selection made via the user interface or auto-select criteria. From operation 406, the method 400 proceeds to operation 408. At operation 408, the data security cube application 108 stores the data cube 110 and the key cube 112 in the secure storage 114. From operation 408, the method 400 proceeds to operation 410. The method 400 can end at operation 410.

Turning now to FIG. 5, a flow diagram illustrating aspects of a method 500 for responding to a text-based data request 116 will be described, according to an illustrative embodiment. The method 500 begins and proceeds to operation 502. At operation 502, the data security cube application 108 receives the data request 116 from the data requestor 118. From operation 502, the method 500 proceeds to operation 504. At operation 504, the data security cube application 108 uses the key cube 112 to look up the binary values 210 in the data cube 110 that correspond to the requested data identified in the data request 116. From operation 504, the method 500 proceeds to operation 506. At operation 506, the data security cube application 108 uses the decryption logic in the key cube 112 to translate the binary values 210 into ASCII text.

From operation 506, the method 500 proceeds to operation 508. At operation 508, the data security cube application 108 determines if a default expiration calculation should be used. The default expiration calculation can identify a time-to-live for any data provided in the data response 124. For example, the user 104 might designate one hour or one day, the expiration of which causes the data to be deleted or otherwise rendered unusable. If the data security cube application 108 determines that the default expiration calculation should be used, the method 500 proceeds to operation 510. At operation 510, the data security cube application 108 calculates the expiration time of the ASCII text based upon the default expiration time. If, however, the data security cube application 108 determines that the default expiration calculation should not be used, the method 500 proceeds to operation 512. At operation 512, the data security cube application 108 prompts the user 104 to enter the expiration time. From operation 510 or operation 512, the method 500 proceeds to operation 514. At operation 514, the data security cube application 108 creates the data response 124, including the ASCII text and the expiration time. From operation 514, the method 500 proceeds to operation 516. At operation 516, the data security cube application 108 sends the data response 124 to the data requestor 118. The data requestor 118 can then process the data response 124, such as by extracting the ASCII text and using the ASCII text as the input required by the data requestor 118. The ASCII text can then expire (e.g., be deleted or rendered unusable) according to the expiration time.

From operation 516, the method 500 proceeds to operation 518. The method 500 can end at operation 518.

Turning now to FIG. 6, a flow diagram illustrating aspects of a method 600 for responding to a data cube-based data request 116 will be described, according to an illustrative embodiment. The method 600 begins and proceeds to operation 602. At operation 602, the data security cube application 108 receives the data request 116 from the data requestor 118. From operation 602, the method 600 proceeds to operation 604. At operation 604, the data security cube application 108 obtains the key layer 302 from the key cube 112 and the corresponding data layer 202 from the data cube 110 for the data identified in the data request 116.

From operation 604, the method 600 proceeds to operation 606. At operation 606, the data security cube application 108 determines if the default expiration calculation should be used. If the data security cube application 108 determines that the default expiration calculation should be used, the method 600 proceeds to operation 608. At operation 608, the data security cube application 108 calculates the expiration time of the key layer 302 and the data layer 202 based upon the default expiration time. If, however, the data security cube application 108 determines that the default expiration calculation should not be used, the method 600 proceeds to operation 610. At operation 610, the data security cube application 108 prompts the user 104 to enter the expiration time. From operation 608 or operation 610, the method 600 proceeds to operation 612. At operation 612, the data security cube application 108 creates the data response 124, including the key layer 302 and the data layer 202 and the expiration time. From operation 612, the method 600 proceeds to operation 614. At operation 614, the data security cube application 108 sends the data response 124 to the data requestor 118. The data requestor 118 can then process the data response 124, such as using the key layer 302 and the data layer 202 to determine the requested data. The key layer 302 and the data layer 202 can then expire according to the expiration time.

From operation 614, the method 600 proceeds to operation 616. The method 600 can end at operation 616.

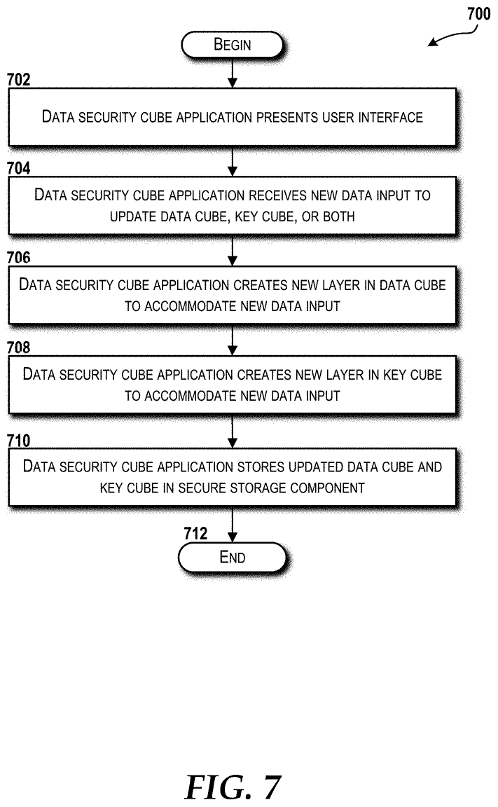

Turning now to FIG. 7, a flow diagram illustrating aspects of a method 700 for updating a data cube 110 and a key cube 112 will be described, according to an illustrative embodiment. The method 700 begins and proceeds to operation 702. At operation 702, the data security cube application 108 presents a user interface. From operation 702, the method 700 proceeds to operation 704. At operation 704, the data security cube application 108 receives new data input 106 to update the data cube 110 the key cube 112. From operation 704, the method 700 proceeds to operation 706. At operation 706, to accommodate the new data input 106, the data security cube application 108 creates a new data layer 202 in the data cube 110. From operation 706, the method 700 proceeds to operation 708. At operation 708, to accommodate the new data input 106, the data security cube application 108 creates a new key layer 302 in the key cube 112 that corresponds to the new data layer 202 in the data cube 110. From operation 708, the method 700 proceeds to operation 710. At operation 710, the data security cube application 108 stores the updated data cube 110 and the updated key cube 112 in the secure storage 114.

From operation 710, the method 700 proceeds to operation 712. The method 700 can end at operation 712.

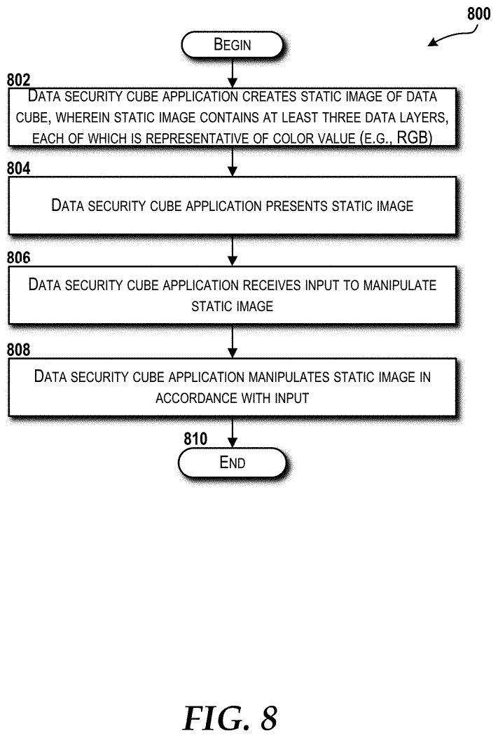

Turning now to FIG. 8, a flow diagram illustrating aspects of a method 800 for creating and manipulating static images of the data cube 110 will be described, according to an illustrative embodiment. The method 800 begins and proceeds to operation 802. At operation 802, the data security cube application 108 creates a static image of the data cube 110. In particular, the data security cube application 108 combines at least three of the data layers 202, wherein each of the data layers 202 represents an RGB color value of a static image. From operation 802, the method 800 proceeds to operation 804. The static image can be used to allow the user to view the data cube 110 in a specific state in time. Multiple static images can be viewed to observe changes to the data cube 110 over time. At operation 804, the data security cube application 108 presents the static image of the data cube 110. From operation 804, the method 800 proceeds to operation 806. At operation 806, the data security cube application 108 receives input to manipulate the static image. From operation 806, the method 800 proceeds to operation 808. At operation 808, the data security cube application 108 manipulates the static image in accordance with the input.

From operation 808, the method 800 proceeds to operation 810. The method 800 can end at operation 810.

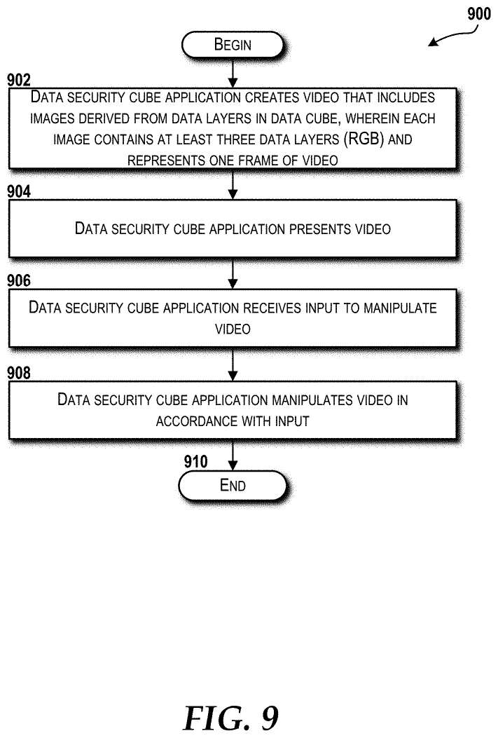

Turning now to FIG. 9, a flow diagram illustrating aspects of a method 900 for creating and manipulating a video of the data cube 110 will be described, according to an illustrative embodiment. The method 900 begins and proceeds to operation 902. At operation 902, the data security cube application 108 creates a video image of the data cube 110. The data security cube application 108 can create the video by sequencing an array of a combination of at least three data layers 202, wherein each data layer 202 is representative of a color value (e.g., RGB) of an image, as an individual frame of the video. Through the video image, the user 104 can view how their data cube 110 changes over time. From operation 902, the method 900 proceeds to operation 904. At operation 904, the data security cube application presents the video image of the data cube 110. From operation 904, the method 900 proceeds to operation 906. At operation 906, the data security cube application 108 receives input to manipulate the video image. From operation 906, the method 900 proceeds to operation 908. At operation 908, the data security cube application 108 manipulates the video image in accordance with the input.

From operation 908, the method 900 proceeds to operation 910. The method 900 can end at operation 910.

Turning now to FIG. 10, a block diagram illustrating a computer system 1000 configured to provide the functionality described herein in accordance with various embodiments of the concepts and technologies disclosed herein. In some embodiments, the user system 102 can be configured the same as or similar to the computer system 1000. In some embodiments, the data requestor 118 can include one or more systems, one or more of which can be configured the same as or similar to the computer system 1000. The computer system 1000 includes a processing unit 1002, a memory 1004, one or more user interface devices 1006, one or more input/output (“I/O”) devices 1008, and one or more network devices 1010, each of which is operatively connected to a system bus 1012. The bus 1012 enables bi-directional communication between the processing unit 1002, the memory 1004, the user interface devices 1006, the I/O devices 1008, and the network devices 1010.

The processing unit 1002 may be a standard central processor that performs arithmetic and logical operations, a more specific purpose programmable logic controller (“PLC”), a programmable gate array, or other type of processor known to those skilled in the art and suitable for controlling the operation of the server computer. The processing unit 1002 can be a single processing unit or a multiple processing unit that includes more than one processing component. Processing units are generally known, and therefore are not described in further detail herein.

The memory 1004 communicates with the processing unit 1002 via the system bus 1012. The memory 1004 can include a single memory component or multiple memory components. In some embodiments, the memory 1004 is operatively connected to a memory controller (not shown) that enables communication with the processing unit 1002 via the system bus 1012. The memory 1004 includes an operating system 1014 and one or more program modules 1016. The operating system 1014 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or LEOPARD families of operating systems from APPLE CORPORATION, the FREEBSD family of operating systems, the SOLARIS family of operating systems from ORACLE CORPORATION, other operating systems, and the like.

The program modules 1016 may include various software and/or program modules described herein. In some embodiments, the program modules 1016 in the user system 102 configured like the computer system 1000 can include, for example, the data security cube application 108. The program modules 1016 and/or other programs can be embodied in computer-readable media containing instructions that, when executed by the processing unit 1002, perform the methods described herein. According to embodiments, the program modules 1016 may be embodied in hardware, software, firmware, or any combination thereof. The memory 1004 to be or to include the secure storage 114 that can store the data cube 110 and the key cube 112, combinations thereof, and/or other data disclosed herein.

By way of example, and not limitation, computer-readable media may include any available computer storage media or communication media that can be accessed by the computer system 1000. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 1000. In the claims, the phrase “computer storage medium,” “computer-readable storage medium,” and variations thereof does not include waves or signals per se and/or communication media, and therefore should be construed as being directed to “non-transitory” media only.

The user interface devices 1006 may include one or more devices with which a user accesses the computer system 1000. The user interface devices 1006 may include, but are not limited to, computers, servers, personal digital assistants, cellular phones, or any suitable computing devices. The I/O devices 1008 enable a user to interface with the program modules 1016. In one embodiment, the I/O devices 1008 are operatively connected to an I/O controller (not shown) that enables communication with the processing unit 1002 via the system bus 1012. The I/O devices 1008 may include one or more input devices, such as, but not limited to, a keyboard, a mouse, or an electronic stylus. Further, the I/O devices 1008 may include one or more output devices, such as, but not limited to, a display screen or a printer.

The network devices 1010 enable the computer system 1000 to communicate with other networks or remote systems via the network 120. Examples of the network devices 1010 include, but are not limited to, a modem, a radio frequency (“RF”) or infrared (“IR”) transceiver, a telephonic interface, a bridge, a router, or a network card. The network 1018 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the network 120 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

Turning now to FIG. 11, an illustrative mobile device 1100 and components thereof will be described. In some embodiments, the user system 102 and/or the data requestor 118 described herein can be configured similar to or the same as the mobile device 1100. While connections are not shown between the various components illustrated in FIG. 11, it should be understood that some, none, or all of the components illustrated in FIG. 11 can be configured to interact with one another to carry out various device functions. In some embodiments, the components are arranged so as to communicate via one or more busses (not shown). Thus, it should be understood that FIG. 11 and the following description are intended to provide a general understanding of a suitable environment in which various aspects of embodiments can be implemented, and should not be construed as being limiting in any way.

As illustrated in FIG. 11, the mobile device 1100 can include a display 1102 for displaying data. According to various embodiments, the display 1102 can be configured to display various GUI elements, text, images, video, virtual keypads and/or keyboards, messaging data, notification messages, metadata, Internet content, device status, time, date, calendar data, device preferences, map and location data, combinations thereof, and/or the like. The mobile device 1100 also can include a processor 1104 and a memory or other data storage device (“memory”) 1106. The processor 1104 can be configured to process data and/or can execute computer-executable instructions stored in the memory 1106. The computer-executable instructions executed by the processor 1104 can include, for example, an operating system 1108, one or more applications 1110, other computer-executable instructions stored in the memory 1106, or the like. In some embodiments, the applications 1110 also can include a UI application (not illustrated in FIG. 11).

The UI application can interface with the operating system 1108 to facilitate user interaction with functionality and/or data stored at the mobile device 1100 and/or stored elsewhere. In some embodiments, the operating system 1108 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 1104 to aid a user in entering/deleting data, entering and setting user IDs and passwords for device access, configuring settings, manipulating content and/or settings, multimode interaction, interacting with other applications 1110, and otherwise facilitating user interaction with the operating system 1108, the applications 1110, and/or other types or instances of data 1112 that can be stored at the mobile device 1100.

The applications 1110, the data 1112, and/or portions thereof can be stored in the memory 1106 and/or in a firmware 1114, and can be executed by the processor 1104. The applications 1110 can include the data security cube application 108, or some combination thereof. The data 1112 can include the data cube 110 and the key cube 112.

The firmware 1114 also can store code for execution during device power up and power down operations. It can be appreciated that the firmware 1114 can be stored in a volatile or non-volatile data storage device including, but not limited to, the memory 1106 and/or a portion thereof.

The mobile device 1100 also can include an input/output (“I/O”) interface 1116. The I/O interface 1116 can be configured to support the input/output of data such as location information, presence status information, user IDs, passwords, and application initiation (start-up) requests. In some embodiments, the I/O interface 1116 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45) port, an RJ11 port, a proprietary port, combinations thereof, or the like. In some embodiments, the mobile device 1100 can be configured to synchronize with another device to transfer content to and/or from the mobile device 1100. In some embodiments, the mobile device 1100 can be configured to receive updates to one or more of the applications 1110 via the I/O interface 1116, though this is not necessarily the case. In some embodiments, the I/O interface 1116 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 1116 may be used for communications between the mobile device 1100 and a network device or local device.

The mobile device 1100 also can include a communications component 1118. The communications component 1118 can be configured to interface with the processor 1104 to facilitate wired and/or wireless communications with one or more networks, such as the network 132, the Internet, or some combination thereof. In some embodiments, the communications component 1118 includes a multimode communications subsystem for facilitating communications via the cellular network and one or more other networks.

The communications component 1118, in some embodiments, includes one or more transceivers. The one or more transceivers, if included, can be configured to communicate over the same and/or different wireless technology standards with respect to one another. For example, in some embodiments, one or more of the transceivers of the communications component 1118 may be configured to communicate using Global System for Mobile communications (“GSM”), Code-Division Multiple Access (“CDMA”) CDMAONE, CDMA2000, Long-Term Evolution (“LTE”) LTE, and various other 2G, 2.5G, 3G, 4G, 4.5G, 5G, and greater generation technology standards. Moreover, the communications component 1118 may facilitate communications over various channel access methods (which may or may not be used by the aforementioned standards) including, but not limited to, Time-Division Multiple Access (“TDMA”), Frequency-Division Multiple Access (“FDMA”), Wideband CDMA (“W-CDMA”), Orthogonal Frequency-Division Multiple Access (“OFDMA”), Space-Division Multiple Access (“SDMA”), and the like.

In addition, the communications component 1118 may facilitate data communications using General Packet Radio Service (“GPRS”), Enhanced Data services for Global Evolution (“EDGE”), the High-Speed Packet Access (“HSPA”) protocol family including High-Speed Downlink Packet Access (“HSDPA”), Enhanced Uplink (“EUL”) (also referred to as High-Speed Uplink Packet Access (“HSUPA”), HSPA+, and various other current and future wireless data access standards. In the illustrated embodiment, the communications component 1118 can include a first transceiver (“TxRx”) 1120A that can operate in a first communications mode (e.g., GSM). The communications component 1118 also can include an N^{th} transceiver (“TxRx”) 1120N that can operate in a second communications mode relative to the first transceiver 1120A (e.g., UMTS). While two transceivers 1120A-1120N (hereinafter collectively and/or generically referred to as “transceivers 1120”) are shown in FIG. 11, it should be appreciated that less than two, two, and/or more than two transceivers 1120 can be included in the communications component 1118.

The communications component 1118 also can include an alternative transceiver (“Alt TxRx”) 1122 for supporting other types and/or standards of communications. According to various contemplated embodiments, the alternative transceiver 1122 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 1118 also can facilitate reception from terrestrial radio networks, digital satellite radio networks, internet-based radio service networks, combinations thereof, and the like. The communications component 1118 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 1100 also can include one or more sensors 1124. The sensors 1124 can include temperature sensors, light sensors, air quality sensors, movement sensors, accelerometers, magnetometers, gyroscopes, infrared sensors, orientation sensors, noise sensors, microphones proximity sensors, combinations thereof, and/or the like. Additionally, audio capabilities for the mobile device 1100 may be provided by an audio I/O component 1126. The audio I/O component 1126 of the mobile device 1100 can include one or more speakers for the output of audio signals, one or more microphones for the collection and/or input of audio signals, and/or other audio input and/or output devices.

The illustrated mobile device 1100 also can include a subscriber identity module (“SIM”) system 1128. The SIM system 1128 can include a universal SIM (“USIM”), a universal integrated circuit card (“UICC”) and/or other identity devices. The SIM system 1128 can include and/or can be connected to or inserted into an interface such as a slot interface 1130. In some embodiments, the slot interface 1130 can be configured to accept insertion of other identity cards or modules for accessing various types of networks. Additionally, or alternatively, the slot interface 1130 can be configured to accept multiple subscriber identity cards. Because other devices and/or modules for identifying users and/or the mobile device 1100 are contemplated, it should be understood that these embodiments are illustrative, and should not be construed as being limiting in any way.

The mobile device 1100 also can include an image capture and processing system 1132 (“image system”). The image system 1132 can be configured to capture or otherwise obtain photos, videos, and/or other visual information. As such, the image system 1132 can include cameras, lenses, charge-coupled devices (“CCDs”), combinations thereof, or the like. The mobile device 1100 may also include a video system 1134. The video system 1134 can be configured to capture, process, record, modify, and/or store video content. Photos and videos obtained using the image system 1132 and the video system 1134, respectively, may be added as message content to an MMS message, email message, and sent to another device. The video and/or photo content also can be shared with other devices via various types of data transfers via wired and/or wireless communication devices as described herein.

The mobile device 1100 also can include one or more location components 1136. The location components 1136 can be configured to send and/or receive signals to determine a geographic location of the mobile device 1100. According to various embodiments, the location components 1136 can send and/or receive signals from global positioning system (“GPS”) devices, assisted-GPS (“A-GPS”) devices, WI-FI/WIMAX and/or cellular network triangulation data, combinations thereof, and the like. The location component 1136 also can be configured to communicate with the communications component 1118 to retrieve triangulation data for determining a location of the mobile device 1100. In some embodiments, the location component 1136 can interface with cellular network nodes, telephone lines, satellites, location transmitters and/or beacons, wireless network transmitters and receivers, combinations thereof, and the like. In some embodiments, the location component 1136 can include and/or can communicate with one or more of the sensors 1124 such as a compass, an accelerometer, and/or a gyroscope to determine the orientation of the mobile device 1100. Using the location component 1136, the mobile device 1100 can generate and/or receive data to identify its geographic location, or to transmit data used by other devices to determine the location of the mobile device 1100. The location component 1136 may include multiple components for determining the location and/or orientation of the mobile device 1100.

The illustrated mobile device 1100 also can include a power source 1138. The power source 1138 can include one or more batteries, power supplies, power cells, and/or other power subsystems including alternating current (“AC”) and/or direct current (“DC”) power devices. The power source 1138 also can interface with an external power system or charging equipment via a power I/O component 1140. Because the mobile device 1100 can include additional and/or alternative components, the above embodiment should be understood as being illustrative of one possible operating environment for various embodiments of the concepts and technologies described herein. The described embodiment of the mobile device 1100 is illustrative, and should not be construed as being limiting in any way.

As used herein, communication media includes computer-executable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

By way of example, and not limitation, computer storage media may include volatile and non-volatile, removable and non-removable media implemented in any method or technology for storage of information such as computer-executable instructions, data structures, program modules, or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the mobile device 1100 or other devices or computers described herein. In the claims, the phrase “computer storage medium,” “computer-readable storage medium,” and variations thereof does not include waves or signals per se and/or communication media, and therefore should be construed as being directed to “non-transitory” media only.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations may take place in the mobile device 1100 in order to store and execute the software components presented herein. It is also contemplated that the mobile device 1100 may not include all of the components shown in FIG. 11, may include other components that are not explicitly shown in FIG. 11, or may utilize an architecture completely different than that shown in FIG. 11.

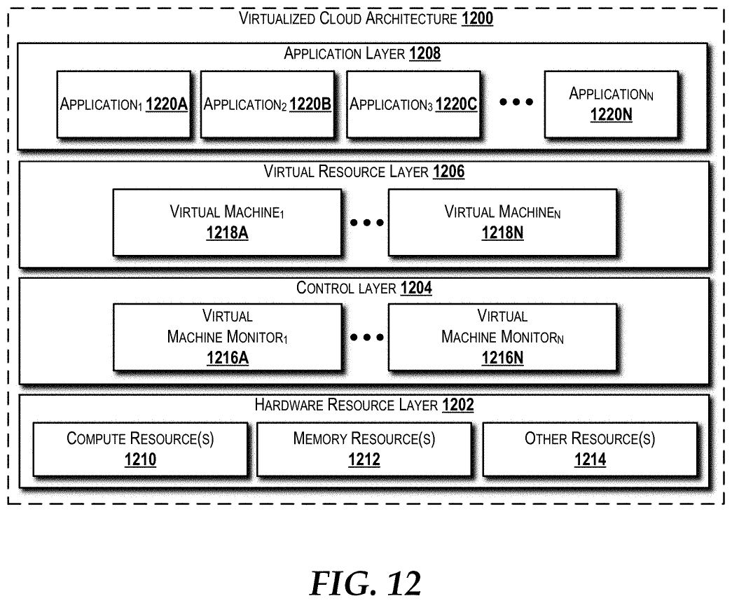

Turning now to FIG. 12, a block diagram illustrating an example virtualized cloud architecture 1200 and components thereof will be described, according to an exemplary embodiment. The virtualized cloud architecture 1200 can be utilized to implement various elements disclosed herein. In some embodiments, the data requestor 118, at least in part, is implemented in the virtualized cloud architecture 1200. For example, the data requestor 118 embodied as a website may be hosted on the virtualized cloud architecture 1200.

The virtualized cloud architecture 1200 is a shared infrastructure that can support multiple services and network applications. The illustrated virtualized cloud architecture 1200 includes a hardware resource layer 1202, a control layer 1204, a virtual resource layer 1206, and an application layer 1208 that work together to perform operations as will be described in detail herein.

The hardware resource layer 1202 provides hardware resources, which, in the illustrated embodiment, include one or more compute resources 1210, one or more memory resources 1212, and one or more other resources 1214. The compute resource(s) 1210 can include one or more hardware components that perform computations to process data, and/or to execute computer-executable instructions of one or more application programs, operating systems, and/or other software. The compute resources 1210 can include one or more central processing units (“CPUs”) configured with one or more processing cores. The compute resources 1210 can include one or more graphics processing unit (“GPU”) configured to accelerate operations performed by one or more CPUs, and/or to perform computations to process data, and/or to execute computer-executable instructions of one or more application programs, operating systems, and/or other software that may or may not include instructions particular to graphics computations. In some embodiments, the compute resources 1210 can include one or more discrete GPUs. In some other embodiments, the compute resources 1210 can include CPU and GPU components that are configured in accordance with a co-processing CPU/GPU computing model, wherein the sequential part of an application executes on the CPU and the computationally-intensive part is accelerated by the GPU. The compute resources 1210 can include one or more system-on-chip (“SoC”) components along with one or more other components, including, for example, one or more of the memory resources 1212, and/or one or more of the other resources 1214. In some embodiments, the compute resources 1210 can be or can include one or more SNAPDRAGON SoCs, available from QUALCOMM; one or more TEGRA SoCs, available from NVIDIA; one or more HUMMINGBIRD SoCs, available from SAMSUNG; one or more Open Multimedia Application Platform (“OMAP”) SoCs, available from TEXAS INSTRUMENTS; one or more customized versions of any of the above SoCs; and/or one or more proprietary SoCs. The compute resources 1210 can be or can include one or more hardware components architected in accordance with an advanced reduced instruction set computing (“RISC”) machine (“ARM”) architecture, available for license from ARM HOLDINGS. Alternatively, the compute resources 1210 can be or can include one or more hardware components architected in accordance with an x86 architecture, such an architecture available from INTEL CORPORATION of Mountain View, Calif., and others. Those skilled in the art will appreciate the implementation of the compute resources 1210 can utilize various computation architectures, and as such, the compute resources 1210 should not be construed as being limited to any particular computation architecture or combination of computation architectures, including those explicitly disclosed herein.

The memory resource(s) 1212 can include one or more hardware components that perform storage operations, including temporary or permanent storage operations. In some embodiments, the memory resource(s) 1212 include volatile and/or non-volatile memory implemented in any method or technology for storage of information such as computer-readable instructions, data structures, program modules, or other data disclosed herein. Computer storage media includes, but is not limited to, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store data and which can be accessed by the compute resources 1210.

The other resource(s) 1214 can include any other hardware resources that can be utilized by the compute resources(s) 1210 and/or the memory resource(s) 1212 to perform operations described herein. The other resource(s) 1214 can include one or more input and/or output processors (e.g., network interface controller or wireless radio), one or more modems, one or more codec chipset, one or more pipeline processors, one or more fast Fourier transform (“FFT”) processors, one or more digital signal processors (“DSPs”), one or more speech synthesizers, and/or the like.

The hardware resources operating within the hardware resources layer 1202 can be virtualized by one or more virtual machine monitors (“VMMs”) 1216A-1216N (also known as “hypervisors”; hereinafter “VMMs 1216”) operating within the control layer 1204 to manage one or more virtual resources that reside in the virtual resource layer 1206. The VMMs 1216 can be or can include software, firmware, and/or hardware that alone or in combination with other software, firmware, and/or hardware, manages one or more virtual resources operating within the virtual resource layer 1206.

The virtual resources operating within the virtual resource layer 1206 can include abstractions of at least a portion of the compute resources 1210, the memory resources 1212, the other resources 1214, or any combination thereof. These abstractions are referred to herein as virtual machines (“VMs”). In the illustrated embodiment, the virtual resource layer 1206 includes VMs 1218A-1218N (hereinafter “VMs 1218”). Each of the VMs 1218 can execute one or more applications 1220A-1220N in the application layer 1208.

Turning now to FIG. 13, details of the network 120 are illustrated, according to an illustrative embodiment. The network 1300 includes a cellular network 1302, a packet data network 1304, and a circuit switched network 1306. The cellular network 1302 can include various components such as, but not limited to, base transceiver stations (“BTSs”), Node-Bs or e-Node-Bs, base station controllers (“BSCs”), radio network controllers (“RNCs”), mobile switching centers (“MSCs”), mobility management entities (“MMEs”), short message service centers (“SMSCs”), multimedia messaging service centers (“MMSCs”), home location registers (“HLRs”), home subscriber servers (“HS S s”), visitor location registers (“VLRs”), charging platforms, billing platforms, voicemail platforms, GPRS core network components, location service nodes, and the like. The cellular network 1302 also includes radios and nodes for receiving and transmitting voice, data, and combinations thereof to and from radio transceivers, networks, the packet data network 1304, and the circuit switched network 1306.

A mobile communications device 1308, such as, for example, the user system 102 embodied as the mobile device 1100, the data requestor 118 embodied as the mobile device 1100, a cellular telephone, a user equipment, a mobile terminal, a PDA, a laptop computer, a handheld computer, and combinations thereof, can be operatively connected to the cellular network 1302. The cellular network 1302 can be configured as a GSM) network and can provide data communications via GPRS and/or EDGE. Additionally, or alternatively, the cellular network 1302 can be configured as a 3G Universal Mobile Telecommunications System (“UMTS”) network and can provide data communications via the HSPA protocol family, for example, HSDPA, EUL, and HSPA+. The cellular network 1302 also is compatible with 4G mobile communications standards such as LTE, 5G mobile communications standards, or the like, as well as evolved and future mobile standards.

The packet data network 1304 includes various systems, devices, servers, computers, databases, and other devices in communication with one another, as is generally known. In some embodiments, the packet data network 1304 is or includes one or more WI-FI networks, each of which can include one or more WI-FI access points, routers, switches, and other WI-FI network components. The packet data network 1304 devices are accessible via one or more network links. The servers often store various files that are provided to a requesting device such as, for example, a computer, a terminal, a smartphone, or the like. Typically, the requesting device includes software for executing a web page in a format readable by the browser or other software. Other files and/or data may be accessible via “links” in the retrieved files, as is generally known. In some embodiments, the packet data network 1304 includes or is in communication with the Internet. The circuit switched network 1306 includes various hardware and software for providing circuit switched communications. The circuit switched network 1306 may include, or may be, what is often referred to as a plain old telephone system (“POTS”). The functionality of a circuit switched network 1306 or other circuit-switched network are generally known and will not be described herein in detail.

The illustrated cellular network 1302 is shown in communication with the packet data network 1304 and a circuit switched network 1306, though it should be appreciated that this is not necessarily the case. One or more Internet-capable devices 1310 such as a laptop, a portable device, or another suitable device, can communicate with one or more cellular networks 1302, and devices connected thereto, through the packet data network 1304. It also should be appreciated that the Internet-capable device 1310 can communicate with the packet data network 1304 through the circuit switched network 1306, the cellular network 1302, and/or via other networks (not illustrated).

As illustrated, a communications device 1312, for example, a telephone, facsimile machine, modem, computer, or the like, can be in communication with the circuit switched network 1306, and therethrough to the packet data network 1304 and/or the cellular network 1302. It should be appreciated that the communications device 1312 can be an Internet-capable device, and can be substantially similar to the Internet-capable device 1310.

Based on the foregoing, it should be appreciated that concepts and technologies directed to a data security cube have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A method comprising:
receiving, by a system comprising a processor executing a data security cube application, user data associated with a user;
creating, by the data security cube application, a data cube comprising at least one data layer comprising the user data represented in a binary format;
creating, by the data security cube application, a key cube comprising at least one key layer comprising a data type of the user data, an element identifier that identifies a location of the user data within the data cube, and a decryption logic that decrypts the user data in the binary format; and
storing, by the data security cube application, the data cube and the key cube in a secure storage component of the system.

2. The method of claim 1, further comprising:
receiving, by the data security cube application, a data request from a data requestor, wherein the data request identifies at least a portion of the user data requested by the data requestor;
performing, by the data security cube application, a lookup operation to obtain at least one binary value that corresponds to at least the portion of the user data;
translating, by the data security cube application, the at least one binary value into an ASCII text;
creating, by the data security cube application, a data response comprising the ASCII text; and
sending, by the data security cube application, the data response to the data requestor.

3. The method of claim 2, further comprising:
determining, by the data security cube application, that a default expiration calculation should be used to calculate an expiration time for the ASCII text; and
calculating, by the data security cube application, based upon the default expiration calculation, the expiration time for the ASCII text;
wherein creating, by the data security cube application, the data response comprises creating, by the data security cube application, the data response further comprises the expiration time for the ASCII text.

4. The method of claim 2, further comprising receiving, by the data security cube application, an expiration time; and wherein creating, by the data security cube application, the data response comprises creating, by the data security cube application, the data response further comprises the expiration time for the ASCII text.

5. The method of claim 1, further comprising:
receiving, by the data security cube application, a data request from a data requestor, wherein the data request identifies at least a portion of the user data requested by the data requestor;
obtaining, by the data security cube application, a key layer from the key cube and a corresponding data layer from the data cube, wherein the corresponding data layer comprises at least a portion of the user data;
creating, by the data security cube application, a data response comprising the key layer and the corresponding data layer; and
sending, by the data security cube application, the data response to the data requestor.

6. The method of claim 5, further comprising:
determining, by the data security cube application, that a default expiration calculation should be used to calculate an expiration time for the key layer and the corresponding data layer; and
calculating, by the data security cube application, based upon the default expiration calculation, the expiration time for the key layer and the corresponding data layer;
wherein creating, by the data security cube application, the data response comprises creating, by the data security cube application, the data response further comprises the expiration time for the key layer and the corresponding data layer.

7. The method of claim 5, further comprising receiving, by the data security cube application, an expiration time; and wherein creating, by the data security cube application, the data response comprises creating, by the data security cube application, the data response further comprises the expiration time for the key layer and the corresponding data layer.

8. The method of claim 1, further comprising:
receiving, by the data security cube application, new user data associated with the user;
creating, by the data security cube application, a new data layer in the data cube to accommodate the new user data, thereby creating an updated data cube;
creating, by the data security cube application, a new key layer in the key cube to accommodate the new user data, thereby creating an updated key cube; and
storing, by the data security cube application, the updated data cube and the updated key cube in the secure storage.

9. The method of claim 1, further comprising:
creating, by the data security cube application, an image of each data layer in the data cube; and
presenting, by the data security cube application, the image of each data layer in the data cube.

10. The method of claim 9, wherein the image comprises a static image or a video image.

11. The method of claim 9, further comprising:
receiving, by the data security cube application, an input to manipulate the image; and
manipulating, by the data security cube application, the image in accordance with the input.

12. A system comprising:
a processor;
a memory that stores instructions of a data security cube application that, when executed by the processor, cause the processor to perform operations comprising
receiving user data associated with a user,
creating a data cube comprising at least one data layer comprising the user data represented in a binary format,
creating a key cube comprising at least one key layer comprising a data type of the user data, an element identifier that identifies a location of the user data within the data cube, and a decryption logic that decrypts the user data in the binary format, and
storing the data cube and the key cube in a secure storage component of the system.

13. The system of claim 12, wherein the operations further comprise:
receiving a data request from a data requestor, wherein the data request identifies at least a portion of the user data requested by the data requestor;
performing a lookup operation to obtain at least one binary value that corresponds to at least the portion of the user data;
translating the at least one binary value into an ASCII text;
creating a data response comprising the ASCII text; and
sending the data response to the data requestor.

14. The system of claim 13, wherein the operations further comprise:
determining that a default expiration calculation should be used to calculate an expiration time for the ASCII text; and
calculating, based upon the default expiration calculation, the expiration time for the ASCII text;
wherein creating the data response comprises creating the data response further comprises the expiration time for the ASCII text.

15. The system of claim 13, wherein the operations further comprise receiving an expiration time; and wherein creating, by the data security cube application, the data response comprises creating, by the data security cube application, the data response further comprises the expiration time for the ASCII text.

16. The system of claim 12, wherein the operations further comprise:
receiving a data request from a data requestor, wherein the data request identifies at least a portion of the user data requested by the data requestor;
obtaining a key layer from the key cube and a corresponding data layer from the data cube, wherein the corresponding data layer comprises at least a portion of the user data;
creating a data response comprising the key layer and the corresponding data layer; and
sending the data response to the data requestor.

17. The system of claim 16, wherein the operations further comprise:
determining that a default expiration calculation should be used to calculate an expiration time for the key layer and the corresponding data layer; and
calculating, based upon the default expiration calculation, the expiration time for the key layer and the corresponding data layer;
wherein creating the data response comprises creating the data response further comprises the expiration time for the key layer and the corresponding data layer.

18. The system of claim 16, wherein the operations further comprise receiving an expiration time; and wherein creating the data response comprises creating the data response further comprises the expiration time for key layer and the corresponding data layer.

19. A computer-readable storage medium having instructions stored thereon that, when executed by a processor of a system, cause the processor to perform operations comprising:
receiving user data associated with a user;
creating a data cube comprising at least one data layer comprising the user data represented in a binary format;
creating a key cube comprising at least one key layer comprising a data type of the user data, an element identifier that identifies a location of the user data within the data cube, and a decryption logic that decrypts the user data in the binary format;
storing the data cube and the key cube in a secure storage component of the system;
receiving a data request from a data requestor, wherein the data request identifies at least a portion of the user data requested by the data requestor;
generating a data response comprising at least the portion of the user data obtained from the data cube and the key cube; and
sending the data response to the data requestor.

20. The computer-readable storage medium of claim 19, wherein at least the portion of the user data obtained from the data cube and the key cube comprises:
an ASCII text; or
a key layer from the key cube and a corresponding data layer from the data cube, wherein the corresponding data layer comprises at least a portion of the user data.
